(19) United States
(12) Patent Application Publication
(10) Pub. No.: US 2025/0113840 A1
(43) Pub. Date: Apr. 10, 2025

(54) SLICED MEAT ANALOGUES AND PRODUCTION THEREOF

(71) Applicant: KELLANOVA, Battle Creek, MI (US)

(72) Inventors: Monjur HOSSEN, Battle Creek, MI (US); Xueqian SHI, Kalamazoo, MI (US); Maurice FITZPATRICK, Battle Creek, MI (US); Jeffrey Neil JERZY, West Bloomfield, MI (US); Megan Kristen MORGAN, Galesburg, MI (US); Stephanie GEERS, Kalamazoo, MI (US)

(21) Appl. No.: 18/834,696

(22) PCT Filed: Jan. 31, 2023
(86) PCT No.: PCT/US2023/061624

§ 371 Date: Jul. 31, 2024

Related U.S. Application Data
(60) Provisional application No. 63/305,360, filed on Feb. 1, 2022.

(51) Int. Cl. A23J 3/22; A23J 3/16; A23J 3/26

(52) U.S. Cl. CPC A23J 3/227; A23J 3/16; A23J 3/26

(57) ABSTRACT

A sliced deli-style, meat-based plant proteins that mimics its meat-based counterpart are described herein are prepared through a composition and method that associate protein components in a manner that can be uniquely processed effective to produce a meat analogue from plant proteins that closely resembles sliced deli-style meats in appearance, taste, texture, and quality. When both the select compositional features and the select processing system parameters are combined, the resulting product achieves thin and elongated slices that have a grainy texture resembling, for instance, sliced roast beef or sliced turkey.

### CROSS REFERENCE TO RELATED APPLICATIONS

This application claims priority under 35 U.S.C. § 119 to U.S. Provisional Application No. 63/305,360 filed on Feb. 1, 2022. The entire contents of the aforementioned application are incorporated herein.

### TECHNICAL FIELD

This disclosure relates to compositions and methods of producing a plant-based, meat analogue resembling sliced, deli-style meat.

### BACKGROUND

Consumer interest in plant-based foods continues to gain interest as people attempt to choose snacks and meals that are healthier and better for both themselves and the environment. The shift to plant-based eating can present a big shift in lifestyle for consumers and meeting this demand depends on the plant-based alternatives tending to closely mimic the meat products they are replacing. Many consumers are unwilling to sacrifice their eating experience when eating plant based foods. Consumers tend to demand that these plant based foods are closely similar to their respective meat analogues in terms of taste, texture, and visual appearance. Although there are several plant based foods that are meat analogues available on the market, there are no known plant based meat analogues that are similar to sliced deli meat, whole cut meat, and/or sliced meat or steak in terms of visual appearance, taste, and texture. There is currently a technical gap in terms of the available methods and compositions currently used by food manufacturers and meeting consumer expectations with regards to taste, texture, and characteristic bite when using and dealing with the organoleptic properties of plant materials attempting to mimic sliced deli meat.

### SUMMARY

In one aspect, a method for extruding a plant-based sliced meat analogue is described herein. In approaches, the method includes preparing an emulsion including a textured vegetable protein mixture, a soy protein emulsion system including an emulsified soy protein isolate, and a separate, non-emulsified soy protein isolate, wherein the textured vegetable protein mixture is hydrated prior to mixing with the soy protein emulsion system and the non-emulsified soy protein isolate; and feeding the emulsion to heating and transport system at a feed rate and transporting the emulsion at a transport rate through the heating and transport system with a rate differential between the feed rate and the transport rate such that the transport rate is higher than the feed rate to produce a meat analogue product from the emulsion have a grainy appearance resembling a sliced-deli meat.

In other embodiments or approaches, the method of the previous paragraph may be combined with one or more optional features or method steps in any combination. In embodiments, the method may include one or more of the following: wherein the textured vegetable proteins mixture includes a blend of textured long fiber protein and a textured medium fiber protein; and/or wherein each of the textured vegetable proteins in the mixture is separately hydrated with about 1 part of the textured vegetable protein to about 1.5 to about 4 parts water; and/or wherein the textured long fiber protein is a textured long fiber soy protein having an elongate fiber size of about 40 mm to about 50 mm and an aspect ratio of about 1.5 to about 2.5; and/or wherein a weight ratio of the textured long fiber protein to the textured medium fiber protein is about 1.5:1 to about 1:1.5; and/or wherein the textured medium fiber protein is a textured medium fiber soy protein having an elongate fiber size of about 20 mm to about 30 mm and an aspect ratio of about 1.2 to about 3.0; and/or wherein the emulsion includes about 30 to about 40 weight percent of a long textured protein fiber, about 30 to about 40 weight percent of a medium textured protein fiber, about 10 to about 20 weight percent of the soy protein emulsion system, and about 2 to about 10 weight percent of the non-emulsified soy protein isolate; and/or wherein a weight ratio of the non-emulsified soy protein isolate to the emulsified soy protein isolate is about 1.7:1 to about 2.5:1; and/or wherein the soy protein emulsion system includes about 50 to about 70 percent water, about 20 to about 30 percent vegetable oil, and about 10 to about 20 percent soy protein isolate; and/or wherein the feed rate is 30 to 40 percent of a maximum feed rate and the conveying rating is about 60 to about 70 percent of a maximum conveying rate; and/or wherein the heating and transport system has a transport channel for transporting the emulsion, the transport channel has an inner surface and an outer surface and both the inner surface and the outer surface are heated to create a temperature gradient of the emulsion therebetween while being transported through the system; and/or wherein the temperature of the inner and the outer surfaces of the transport channel are both heated to about 85° C. to about 100° C.; and/or wherein the emulsion is transported through the heating and transport system using a single screw having a pitch of less than 8 mm; and/or wherein the pitch of the single screw is 2 to 5 mm; and/or wherein the single screw is steam heated.

In other embodiments or approaches, a meat analog composition having an appearance mimicking sliced deli-style meats is described herein. In approaches, the meat analog may be prepared by any of the method steps of the previous two paragraphs. In other approaches, the meat analog composition includes an emulsion including a textured vegetable protein mixture, a soy protein emulsion system including an emulsified soy protein isolate, a separate, non-emulsified soy protein isolate, and a potato protein, wherein the textured vegetable protein mixture is hydrated prior to mixing with the soy protein emulsion system and the non-emulsified soy protein isolate.

In other embodiments or approaches, the composition of the previous paragraph may be combined with or include optional features. These optional features may include any of the following in any combination: wherein the textured vegetable proteins mixture includes a blend of textured long fiber protein and a textured medium fiber protein; and/or wherein each of the textured vegetable proteins in the mixture is separately hydrated with about 1 part of the textured vegetable protein to about 1.5 to about 4 parts water; and/or wherein the textured long fiber protein is a textured long fiber soy protein having an elongate fiber size of about 40 mm to about 50 mm and an aspect ratio of about 1.5 to about 2.5; and/or wherein a weight ratio of the textured long fiber protein to the textured medium fiber protein is about 1.5:1 to about 1:1.5; and/or wherein the textured medium fiber protein is a textured medium fiber soy protein having an elongate fiber size of about 20 mm to about 30 mm and an aspect ratio of about 1.2 to about 3.0; and/or wherein the emulsion includes about 30 to about 40 weight percent of a long textured protein fiber, about 30 to about 40 weight percent of a medium textured protein fiber, about 10 to about 20 weight percent of the soy protein emulsion system, and about 2 to about 10 weight percent of the non-emulsified soy protein isolate; and/or wherein a weight ratio of the non-emulsified soy protein isolate to the emulsified soy protein isolate is about 1.7:1 to about 2.5:1; and/or wherein the soy protein emulsion system includes about 50 to about 70 percent water, about 20 to about 30 percent vegetable oil, and about 10 to about 20 percent soy protein isolate; and/or wherein the composition includes about 4 to about 10 weight percent of the potato protein, wherein the potato protein is preferably a potato protein isolate.

The details of one or more implementations of the disclosure are set forth in the accompanying drawings and the description below. Other aspects, features, and advantages will be apparent from the description and drawings, and from the claims.

### DESCRIPTION OF DRAWINGS

The drawings described herein are for illustrative purposes only of selected configurations and not all possible implementations, and are not intended to limit the scope of the present disclosure.

FIG. 1 and FIG. 1A are images of a vegetable based protein emulsion processed through a heating and conveying system in a manner to resemble deli-style sliced meat (FIG. 1A is a photograph of the image of FIG. 1); and

FIG. 2 and FIG. 2A are images of a comparative vegetable based protein emulsion processed through the heating and conveying system that does not resemble deli-style sliced meat (FIG. 2A is a photograph of the image of FIG. 2).

### DETAILED DESCRIPTION

The substitution of meat proteins with vegetables and other non-meat proteins by consumers can be motivated by the consumer's decision to improve their health and wellness, in addition to being more sustainable for the environment. Consumer acceptance of meat-like products formulated from plant or vegetable based proteins is in a large part predicated on the appearance, texture, taste, and bite/chewiness as compared to similar meat products. The duplication of these organoleptic properties to match those found in natural meat products is difficult both in terms of compositions and processing. The methods and compositions disclosed herein find a synergy that provides vegetable based sliced-meat analogues that have a similar appearance to their traditional deli meat products in addition to a similar taste and texture. The keys to solving the technical gaps in delivering a desirable consumer experience with respect to these organoleptic properties in the context of sliced meat analogues are addressed by the unique combination of the preparation methods and the compositions disclosed herein.

In one aspect, sliced deli-style, meat-based plant proteins that mimic its meat-based counterpart have a select composition and are processed using a unique extruder system effective to produce a meat analogue from plant proteins that closely resembles sliced deli-style meats in appearance, taste, texture, and quality. When both the select compositional features and the select extruder system parameters are combined, the resulting product achieves thin and elongated slices of extrudate that have a grainy texture resembling, for instance, sliced roast beef or sliced turkey. In approaches, the composition includes select blends of textured protein combined with a particular emulsion system and the processing methods include an extrusion system whereby a unique rate differential between a feed rate and conveying rate surprisingly produces a grain-like texture that closely resembles sliced deli-style meats.

In one aspect, the composition for producing deli-style cut meats using plant based proteins includes at least a select three-component plant-based protein mix including at least one or more textured vegetable proteins, potato proteins, and one or more soy proteins. The textured vegetable proteins preferably are included in two discrete forms providing both long and medium sized textured fibers and the soy proteins preferably are provided both in an isolate form and an emulsion form. While soy proteins are preferably used for the textured proteins, other textured vegetable fiber proteins are also suitable as needed for a particular application.

The textured fiber proteins preferably includes a blend of two different textured proteins. The first textured fiber protein is a long size textured fiber protein. In this form, the textured long fiber protein may include a textured long fiber soy protein or a soy chunk having an elongate size, before hydration, of about 40 mm to about 50 mm by about 20 mm to about 25 mm with an aspect ratio of about 1.5:1 to about 2.5:1. The long fiber protein is preferably soy protein, such as a soy protein isolate, with at least 70 weight percent protein dry basis (about 70 to about 80 percent), but may also include vital wheat gluten and starch within the long fiber protein mixture.

The textured long fiber protein is separately hydrated before combining with other composition ingredients. In one approach, the textured long fiber protein is hydrated for about 1 to about 10 minutes in water or other fluid at a temperature of about 20 to about 50 C. In approaches, hydration may occur with at least one part of the textured fiber protein to about 1.5 to about 4 parts water or other fluid, and in yet other approaches, about 1.5 to about 3 parts water, and in still other approaches about 2 to about 3 parts water or other fluid. The compositions herein preferably include about 30 to about 40 percent of the long size textured fiber protein.

The second textured fiber protein is a medium size textured fiber protein. In this second form, the textured medium fiber protein is a textured medium fiber soy protein or soy granule having an elongate fiber size of from about 20 to about 25 mm by 10 to about 15 mm with an aspect ratio of about 1.2:1 to about 2.5:1. Similar to the texturized long fiber protein, the texturized medium fiber protein is a soy protein, such as a soy protein isolate, and having at least about 68% protein dry basis (60 to 75%) and may also include starch within the mixture.

Like the long fiber protein, the texturized medium fiber protein is separately hydrated before combination with other components. In one approach, the texturized medium fiber protein is also hydrated for about 1 to about 10 minutes in water at a temperature of about 20 to about 50 C. While the texturized medium fiber protein is typically hydrated separately from the long fiber, it may also be hydrated together with the long fiber protein. In approaches, hydration may occur with at least one part of the textured fiber protein to about 1.5 to about 4 parts water or other fluid, and in yet other approaches, about 1.5 to about 3 parts water, and in still other approaches about 2 to about 3 parts water or other fluid. The compositions herein also preferably include about 30 to about 40 percent of the medium size textured fiber protein.

In yet other approaches, the compositions herein have a blend ratio of the long to medium size textured proteins of 1.5:1 to a 1:1.5 and, preferably, 1:1.

The composition also includes a soy emulsion system and, in some instances, includes about 10 weight percent to less than 20 weight percent of the soy emulsion, and preferably about 12 to about 18 weight percent. In one approach, the soy emulsion system is an oil-in-water system including a majority of water with an oil and a dispersed soy protein isolate. In approaches, this emulsion includes about 50 to about 70 weight percent water, about 20 to about 30 weight percent vegetable oil, and about 10 to about 20 weight percent dispersed soy protein isolate. Vegetable oils for the emulsion may be soybean oil, sunflower oil, olive oil, or combinations thereof.

In some approaches and discussed further below, the compositions include at least 4 times the amount of textured vegetable protein (combined long and medium fiber) relative to the soy protein emulsion. Less than this relationship (that is, too much soy emulsion relative to the total textured fiber protein) results in extruded product that does not favorably resemble sliced meat.

The compositions herein also include a separate source of soy protein isolate not in emulsion form. In approaches, the compositions includes about 2 to about 10 weight percent of non-emulsified soy protein isolate and, in some instances, the compositions have more soy protein isolate provided in a non-emulsified form where the compositions have a ratio of about 1.7:1 to about 2.5:1 of the non-emulsified to the emulsified forms of the soy protein isolate.

The compositions also include a third form of protein in the form of potato proteins; preferably, in the form of potato protein isolate. In some embodiments, the compositions includes about 2 to about 10 percent potato protein isolate.

In some aspects, one or more additional ingredients may be added including glycerin, seasoning, gums, vegetable juice (such as beet juice for color), dextrose, and mixtures thereof. Exemplary gums, bulking agents, carrageenan, cellulose gel and cellulose gum, guar gum, gum Arabic, tamarind tum, dextrose, and modified starch such as cooked grains. Other possible ingredients include flavors, colors, seasonings (salt, spices, etc.), fruit juice, fruit concentrate, and fruit powders.

Turning to the method of producing the plant based sliced meats, the compositions described above are matched with select processing conditions in order to form the meat analogues that resemble the traditional sliced-deli meat appearance of typical sliced roast beef, turkey, and the like. In one approach, the method includes first separately hydrating each of the textured vegetable protein mixture to form a fibrous mass as discussed above and then combining with the remaining ingredients to form an emulsion. The emulsion is then processed in a heating and conveying system configured to match heating and conveying conditions that unexpectedly produce thin and elongate strips having the grain texture and cohesiveness of deli-style meats.

Once the emulsion is formed, it is fed to the heating and transport system, which is some approaches, is a single screw extruder or the like configured for transport of product with little to no mechanical working of the emulsion therein. In one approach, the emulsion is fed to heating and transport system at a feed rate and the emulsion is then conveyed via a transport rate through the heating and transport system with a select rate differential between the feed rate and the transport rate. In some embodiments, the transport rate conveying the emulsion through the system is higher than the feed rate to produce a meat analogue product from the emulsion having a grainy appearance resembling a sliced-deli meat. Preferably, the rate differential between the feed rate and the transport rate is such that the feed may be run at 30 to 40 percent of max feed rate and the conveying rate may be 60 to 70 percent of the max feed rate.

In other approaches, the heating and transport system is configured with a transport channel for conveying and/or otherwise transporting the emulsion while being heated at the same time. In some approaches, the transport channel has both a heated inner surface and a heated outer surface. Uniquely, with both the inner surface and the outer surface being heated, such configuration creates a temperature gradient of the emulsion therebetween while being transported through the system. The temperatures of the inner and outer surfaces are preferably at least about 85° C. and, in other approaches, both surfaces are heated to about 85° C. to about 100° C. Steam heating may be used and the steam to the inner surfaces may be 0.1 to 0.2 bar and the steam to the outer surfaces may be about 0.4 to about 0.5 bar.

To convey the emulsion through the heating and transport system, a conveying device, such as a rotary screw or other elongate pushing mechanism may be used. In some approaches, a single screw having a helical pitch of less than 8 mm is beneficial to produce product having the designed appearance and texture. In other approaches, the pitch of the single screw is 2 to 5 mm. Pitch dimensions of 8 mm or more tend not to create sufficient intimate mixing of the emulsion to form the desired consistency to recreate the deli-style appearance. In some approaches, the single screw outer surface provides the heated inner surface of the channel and, in approaches, the screw is heated to temperatures of at least about 85° C. and, in other approaches, both surfaces are heated to about 85° C. to about 100° C.

### EXAMPLES

The following examples are illustrative, but are not meant to be limiting, of the methods and compositions of the present disclosure. Other suitable modifications and adaptations of the variety of conditions and parameters normally encountered in the field, and which are obvious to those skilled in the art, are within the spirit and scope of the disclosure. Unless specified otherwise in this disclosure, all percentages, ratios, or amounts in the following Examples and elsewhere in this disclosure are by weight.

### Example 1

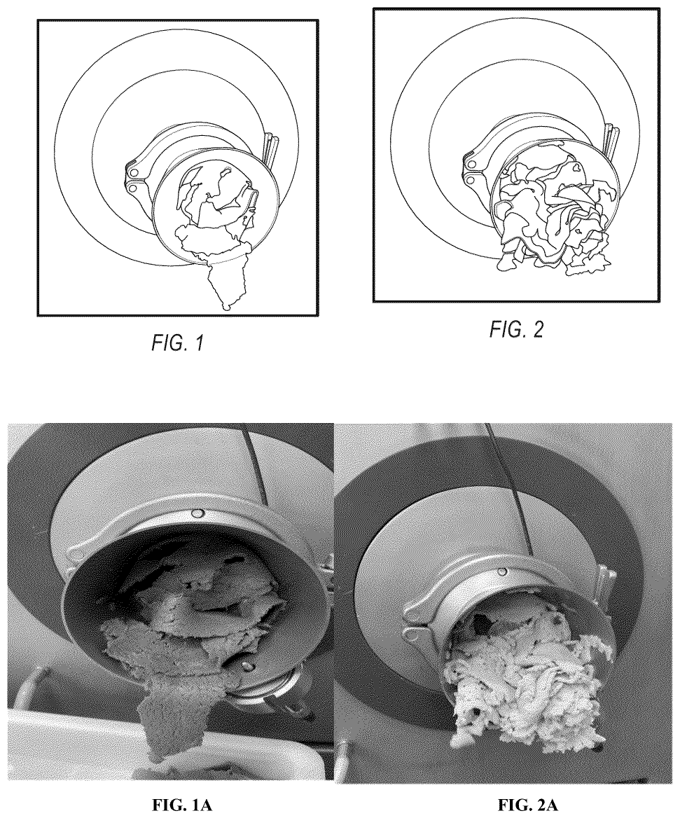

An emulsion was prepared using the composition of Table 1 and processed using a heating and conveying system consistent with the present disclosure. The composition was processed using a single screw extruder having a helical screw with a 3 mm pitch. The resulting product is shown in FIG. 1 and FIG. 1A resembling deli-style sliced meat.

TABLE 1

| | Amount, |
|---|---|
| Ingredients | weight percent |
| Hydrated long soy textured vegetable protein (TVP) (1:3 | 34.6 |
| TVP:Water) | |
| Hydrated med soy TVP (1:3 TVP:Water) | 34.6 |
| Soy Emulsion System (including 12.5% of soy protein | 17.3 |
| isolate) | |
| Potato Protein Isolate | 6 |
| Soy Protein Isolate | 4 |
| Flavors, seasoning, and color | 3.1 |
| Dextrose | 0.4 |

### Comparative Example 1

A comparative emulsion was prepared using the composition of Table 2 and processed using a heating and conveying system consistent with the present disclosure. The composition was also processed using a single screw extruder having a helical screw with a 3 mm pitch. The resulting product is shown in FIG. 2 and FIG. 2A that did not have sufficient cohesiveness or grain texture of typical deli-style sliced meat.

TABLE 2

| | Amount, |
|---|---|
| Ingredients | weight percent |
| Hydrated long soy TVP (1:3 TVP:Water) | 20.68 |
| Hydrated med soy TVP (1:3 TVP:Water) | 40.68 |
| Soy Emulsion System (including 12.5% soy | 20 |
| protein isolate) | |
| Potato Protein Isolate | 10 |
| Soy Protein Isolate | 4 |
| Flavors and seasoning | 4.25 |
| Dextrose | 0.4 |

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method for extruding a plant-based sliced meat analogue, the method comprising:
preparing an emulsion including a textured vegetable protein mixture, a soy protein emulsion system including an emulsified soy protein isolate, and a separate, non-emulsified soy protein isolate, wherein the textured vegetable protein mixture is hydrated prior to mixing with the soy protein emulsion system and the non-emulsified soy protein isolate; and
feeding the emulsion to heating and transport system at a feed rate and transporting the emulsion at a transport rate through the heating and transport system with a rate differential between the feed rate and the transport rate such that the transport rate is higher than the feed rate to produce a meat analogue product from the emulsion have a grainy appearance resembling a sliced-deli meat.

2. The method of claim 1, wherein the textured vegetable proteins mixture includes a blend of textured long fiber protein and a textured medium fiber protein.

3. The method of claim 2, wherein each of the textured vegetable proteins in the mixture is separately hydrated with about 1 part of the textured vegetable protein to about 1.5 to about 4 parts water.

4. The method of claim 2, wherein the textured long fiber protein is a textured long fiber soy protein having an elongate fiber size of about 40 mm to about 50 mm and an aspect ratio of about 1.5 to about 2.5.

5. The method of claim 2, wherein a weight ratio of the textured long fiber protein to the textured medium fiber protein is about 1.5:1 to about 1:1.5.

6. The method of claim 2, wherein the textured medium fiber protein is a textured medium fiber soy protein having an elongate fiber size of about 20 mm to about 30 mm and an aspect ratio of about 1.2 to about 3.0.

7. The method of claim 1, wherein the emulsion includes about 30 to about 40 weight percent of a long textured protein fiber, about 30 to about 40 weight percent of a medium textured protein fiber, about 10 to about 20 weight percent of the soy protein emulsion system, and about 2 to about 10 weight percent of the non-emulsified soy protein isolate.

8. The method of claim 7, wherein a weight ratio of the non-emulsified soy protein isolate to the emulsified soy protein isolate is about 1.7:1 to about 2.5:1.

9. The method of claim 1, wherein the soy protein emulsion system includes about 50 to about 70 percent water, about 20 to about 30 percent vegetable oil, and about 10 to about 20 percent soy protein isolate.

10. The method of claim 1, wherein the feed rate is 30 to 40 percent of a maximum feed rate and the conveying rating is about 60 to about 70 percent of a maximum conveying rate.

11. The method of claim 10, wherein the heating and transport system has a transport channel for transporting the emulsion, the transport channel has an inner surface and an outer surface and both the inner surface and the outer surface are heated to create a temperature gradient of the emulsion therebetween while being transported through the system.

12. The method of claim 11, wherein the temperature of the inner and the outer surfaces of the transport channel are both heated to about 85° C. to about 100° C.

13. The method of claim 10, wherein the emulsion is transported through the heating and transport system using a single screw having a pitch of less than 8 mm.

14. The method of claim 13, wherein the pitch of the single screw is 2 to 5 mm.

15. The method of claim, wherein the single screw is steam heated.

16. A meat analog composition having an appearance mimicking sliced deli-style meats, the meat analog composition comprising:
an emulsion including a textured vegetable protein mixture, a soy protein emulsion system including an emulsified soy protein isolate, a separate, non-emulsified soy protein isolate, and a potato protein, wherein the textured vegetable protein mixture is hydrated prior to mixing with the soy protein emulsion system and the non-emulsified soy protein isolate.

17. The meat analog of claim 16, wherein the textured vegetable proteins mixture includes a blend of textured long fiber protein and a textured medium fiber protein.

18. The meat analog of claim 17, wherein each of the textured vegetable proteins in the mixture is separately hydrated with about 1 part of the textured vegetable protein to about 1.5 to about 4 parts water.

19. The meat analog of claim 17, wherein the textured long fiber protein is a textured long fiber soy protein having an elongate fiber size of about 40 mm to about 50 mm and an aspect ratio of about 1.5 to about 2.5.

20. The meat analog of claim 17, wherein a weight ratio of the textured long fiber protein to the textured medium fiber protein is about 1.5:1 to about 1:1.5.

21. The meat analog of claim 17, wherein the textured medium fiber protein is a textured medium fiber soy protein having an elongate fiber size of about 20 mm to about 30 mm and an aspect ratio of about 1.2 to about 3.0.

22. The meat analog of claim 16, wherein the emulsion includes about 30 to about 40 weight percent of a long textured protein fiber, about 30 to about 40 weight percent of a medium textured protein fiber, about 10 to about 20 weight percent of the soy protein emulsion system, and about 2 to about 10 weight percent of the non-emulsified soy protein isolate.

23. The meat analog of claim 22, wherein a weight ratio of the non-emulsified soy protein isolate to the emulsified soy protein isolate is about 1.7:1 to about 2.5:1.

24. The meat analog of claim 16, wherein the soy protein emulsion system includes about 50 to about 70 percent water, about 20 to about 30 percent vegetable oil, and about 10 to about 20 percent soy protein isolate.

25. The meat analog of claim 16, wherein the composition includes about 4 to about 10 weight percent of the potato protein, wherein the potato protein is preferably a potato protein isolate.
